(19) United States
(12) Patent Application Publication
(10) Pub. No.: US 2019/0276971 A1
(43) Pub. Date: Sep. 12, 2019

(54) WATER SEAL CLUTCH AND WASHING MACHINE THEREFOR

(71) Applicant: ANHUI JULONG TRANSMISSION TECHNOLOGY CO., LTD., Anhui (CN)

(72) Inventor: Jun LIU, Anhui (CN)

(21) Appl. No.: 16/346,578

(22) PCT Filed: Nov. 2, 2017
(86) PCT No.: PCT/CN2017/000661

§ 371 Date: May 1, 2019

(30) Foreign Application Priority Data
Nov. 3, 2016 (CN) 201621179586.3
Oct. 31, 2017 (CN) 201721433671.2

(51) Int. Cl. D06F 37/30; D06F 39/00; F16J 15/3232

(52) U.S. Cl. CPC D06F 37/30; F16J 15/3232; D06F 39/006

(57) ABSTRACT

A water-sealed clutch and a washing machine thereof. The said clutch has a mechanical sealing device. The said clutch has a function of connecting the inside of the wash bucket with the outside of the external bucket, allowing water in the wash bucket to directly connect with the air chamber of the water level sensor of the outside of the external bucket. There is no water between the external bucket and wash bucket. On the upper shaft sleeve of the clutch is a connecting plate, with a number of limber holes thereon. A connecting ring is fixed on the connecting plate. A cavity shell composed of an upper cavity cover and a lower cavity cover is inserted into the big water-seal groove of the clutch, and is fixed to the bottom plate of the mounting plate of the clutch. An upper water-seal having an inner diameter matching the above-mentioned connecting ring is fixed to the upper cover of the cavity. The clutch of this invention is directly mounted to the bottom of the external bucket of the washing machine, passes through the central hole of the bottom of the external bucket, and is sealed and matched with the external bucket through the gasket of the outer edge of the upper cover of the cavity. The wash bucket flange matches the connecting plate on the clutch, and there is an O-ring seal between the flange and the O-ring for sealing.

### TECHNICAL FIELD

This invention relates to the technical field of environmentally friendly washing machines with holeless internal buckets, in particular to a water-sealed clutch and the washing machine thereof.

### BACKGROUND

In order to solve the problems of water saving and secondary pollution of fully automatic pulsator or roller washing machines, an environmentally friendly washing machine, namely a washing machine with a holeless cylindric washer, has been developed in the industry. For example, the structure of the pulsator washing machine is an integrated design for the lower part of the inner cylinder. For the bucket wall, only the position near the balance ring has a circle of water-draining holes, and the other positions have no holes. During washing, the inner cylinder of the washing machine of such structure contains water, and there is no water between the inner cylinder and the cabinet, which solves the problems of water saving and secondary pollution. To perform such a function, a cavity cover is generally installed in the bottom of the external bucket, and an upper water-seal is fixedly mounted on the cavity cover. An inverted steel bowl is installed between the washing bucket flange and the upper shaft sleeve, and the inverted bowl flexibly matches the upper water-seal to form a relatively sealed cavity, so that the wash bucket is dynamically connected with the outside. Such structure is feasible in theory. In fact, however, the inverted bowl is installed at the bottom of the washing bucket flange during the assembly process, and the cavity cover is fixed to the inner side of the bottom of the external bucket by screws or welding. As a result, it is difficult for the inverted bowl and the upper water-seal installed on the cavity cover to ensure the coaxiality, which is very likely to cause mechanical wear, and abrade and disable the lip of the water-seal, causing water leakage. For dual-power washing machines and three-power washing machines, in particular, the wash bucket also needs to rotate in the washing process, which causes leakage more easily. With the existing technology, the inverted bowl structure is cylindrical, and the limber holes have a very small size due to the structural constraint, which easily causes blockage here.

### TECHNICAL SOLUTION

The basic objective of this invention is to provide a water-sealed clutch and a washing machine thereof to solve the problems of water leakage and blockage in such environmentally-friendly water-saving washing machines in the current market.

A water-sealed clutch, where a mechanical seal device is added based on the traditional clutch. That is, a connecting plate is installed on the upper shaft sleeve of the clutch, and the connecting plate has a number of limber holes. On the connecting plate is a downward connecting ring. The said connecting plate is an inverted steel bowl which is fixedly mounted with the upper sleeve of the clutch. The said connecting ring is a stainless steel sleeve, and the inverted steel bowl and the stainless steel sleeve are sealed and fixed together, by means of forced fit or welding, etc. The two form a xenogenous inverted steel bowl, which increases the cross-sectional area of the limber holes.

Further, a cavity shell composed of the upper cover of the cavity and lower cover of the cavity is inserted into the groove of the big water-seal of the clutch, and is fixedly connected with the bottom plate of the mounting plate of the clutch. An upper water-seal with an inner diameter matching the above stainless steel sleeve or connecting ring is fixed in the upper cover of the cavity. In this way, the upper cover of the cavity, lower cover of the cavity, upper water-seal, stainless steel sleeve/connecting ring, big water-seal of the clutch, upper shaft sleeve the clutch, etc. form a cavity. In the upper part, the limber hole connects with the inside of the wash bucket. In the lower part, the internal outlet is arranged at the lower position of the lower cavity cover, and connects with the outside of the external bucket via the mounting plate of the clutch. Between the upper water-seal and the stainless steel sleeve/connecting ring is a rotary sealing structure, which ensures no water leakage in the wash bucket while the stainless steel sleeve rotates with the upper sleeve and the inverted steel bowl.

Further, the clutch used here may be an ordinary deceleration clutch, or a dual-power clutch or a three-power clutch, etc. During the washing process, the wash bucket is allowed to rotate or not to rotate.

Further, the inverted steel bowl has a circular bowl-like structure and is coaxially mounted on the upper shaft sleeve of the clutch. The stainless steel sleeve has a circular structure, which is sealed and fixed with the inverted steel bowl, and ensures that the ring surface of the stainless steel sleeve that matches the water-seal is coaxially mounted with the upper shaft sleeve of the clutch. The stainless steel sleeve has an inner diameter of between 40 mm and 100 mm. The upper sleeve of the clutch here has a diameter of 25 mm and a water passage section of 8 cm² or above.

Further, the upper cover of the cavity and lower cover of the cavity are both of the circular structure, and are coaxially and hermetically fixed together. A positioning structure can be designed between the two, and plate welding or bolts plus sealing strips may be used for connection to ensure no water leakage between the two, and to ensure coaxiality between the two. The upper cover of the cavity has a structure that fixes the upper water-seal, and ensures coaxiality between the upper water-seal and upper cover of the cavity. The lower end of the lower cover of the cavity has a circle of ring reinforcements which fit tightly with the groove of the big water-seal of the clutch, ensure that the lower cover of the cavity and the upper shaft sleeve of the clutch are coaxially mounted, and ensure coaxiality between the two. The upper cover of the cavity and the lower cover of the cavity, which are fixed together, are fixedly connected to the mounting plate of the clutch, which ensures coaxiality between the upper water-seal and upper shaft sleeve.

Further, the said upper cover of the cavity and the upper water-seal are made of the same materials into one piece.

Further, an internal outlet is provided at the lower end of the lower cover of the cavity. A hole is formed in the corresponding position on the mounting plate of the clutch, so that the internal outlet protrudes to the bottom surface under the mounting plate of the clutch.

Further, there is an O-ring seal around the outer side of the inverted steel bowl and a gasket around the upper cover of the cavity.

In this way, a mechanical seal structure is added to the conventional clutch, and a water-sealed clutch is formed, creating a perfect overall structure.

A water-saving washing machine contains the above water-sealed clutch. The washing machine using the sealed clutch is a holeless wash-bucket washing machine. The wash bucket body of the washing machine and the bottom of the wash bucket are fixedly connected together. In the washing bucket body, only the position in the upper part near the balance ring has a circle of water-draining holes, and the other positions are of a holeless structure. The bottom of the wash bucket is sealed and fixed with the flange. When the whole machine is installed and when the flange is fixedly connected with the upper sleeve of the clutch, the inner surface of the flange is pressed on the O-ring on the inverted steel bowl, and the flange and the O-ring are sealed and match each other.

Further, a round hole may be arranged in the middle of the bottom of the external bucket, which may allow the upper half of the water-sealed clutch to pass. The structure around the outer side of the round hole at the bottom of the external bucket is a plane structure. When the water-sealed clutch is installed at the bottom of the external bucket, the gasket is pressed against the end surface of the upper cover of the cavity and the peripheral ring surface of the through hole at the middle of the outer bottom of the external bucket to allow the upper cover of the cavity and the through hole to seal and match each other.

Further, the through hole at the middle of the bottom of the external bucket can be designed with a ring flange on the inner side, which increases the strength here while ensuring no leakage here. An external outlet is provided outside the cavity of the bottom of the external bucket. The external outlet may be connected with the water outlet of the drain valve of the washing machine, or drains away water separately. Outside the bottom cavity of the external bucket, there is no water in the process of washing, water intake, water drainage, etc., and there is water at the bottom of the external bucket only during high-speed dewatering. As a result, as long as the external outlet is big enough, the water thrown flows out quickly, and no water flows through the through hole, thus avoiding water leakage.

Further, the internal outlet connects with the water inlet of the drain valve through the water pipe, and meanwhile connects with the air chamber of the water level sensor.

When water flows in, it flows in from the inlet valve, enters the wash bucket, enters the cavity from the limber holes, enters the water pipe from the internal outlet, and enters the air chamber of the water level sensor. The water level sensor senses the water level, and starts the washing mode when the water level reaches the set water level.

After washing is finished, the drainage mode starts. In water drainage, the drain valve opens first. Water in the wash bucket passes through the limber holes, cavity chamber, internal outlet and water pipe, and enters the water inlet of the drain valve. Since the drain valve is open, water is discharged. Meanwhile the water level sensor can still sense the amount of water in wash bucket. After water is emptied, the washing machine enters the dewatering state. Water in the wash bucket is partially discharged from the internal outlet, and is partially thrown out from the water-draining hole on the wash bucket body as a result of the centrifugal force, enters the external bucket, and then is discharged from the external outlet.

In terms of solving practical problems, this invention installs the cavity and the upper water-seal thereof and the matching inverted steel bowl on the clutch, ensures the coaxiality thereof, and divides the inverted steel bowl into two parts for processing, then combines them into a xenogenous structure which can greatly increase the cross section of the limber hole section and avoid blockage here.

### DESCRIPTION FOR ATTACHED DRAWINGS

FIG. 1 is a structure diagram of the water-sealed clutch of this invention;

FIG. 2 is a structure diagram of the washing machine using the water-sealed clutch of this invention;

FIG. 3 is another structure diagram of a water-sealed clutch of this invention;

FIG. 4 is the structure diagram of the said upper water-seal in FIG. 3;

FIG. 5 is the sectional view of A-A in FIG. 4;

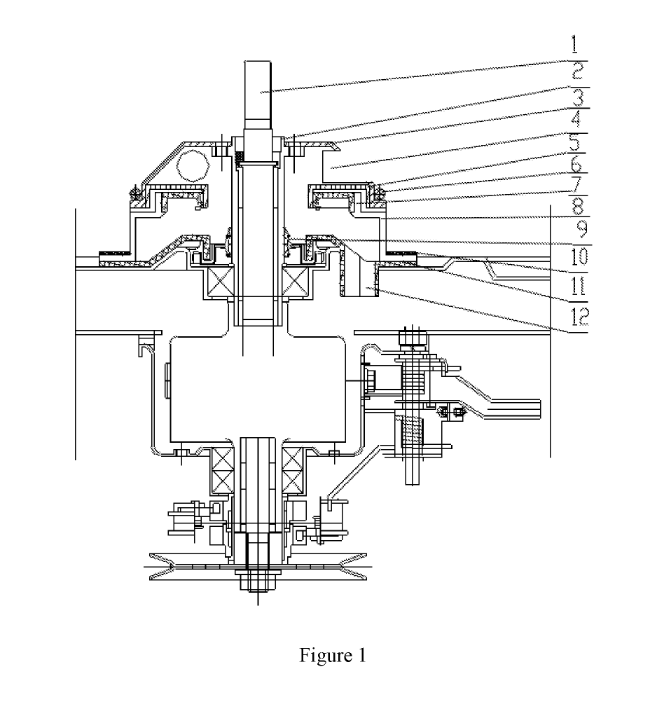

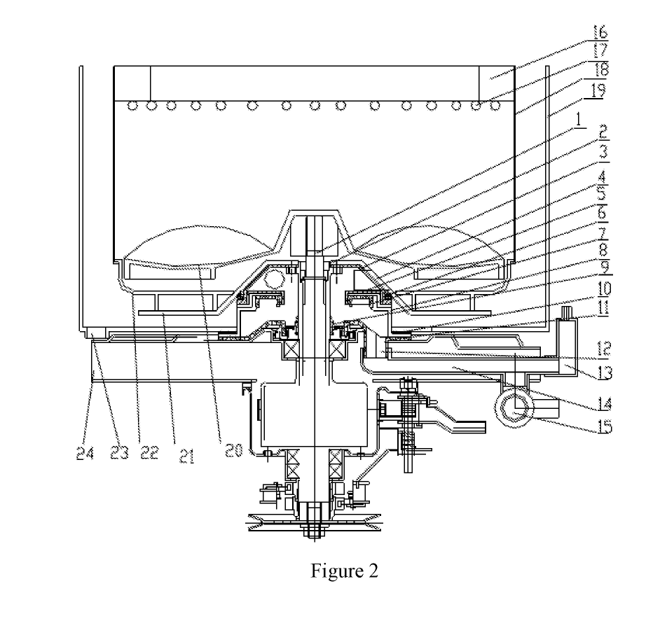

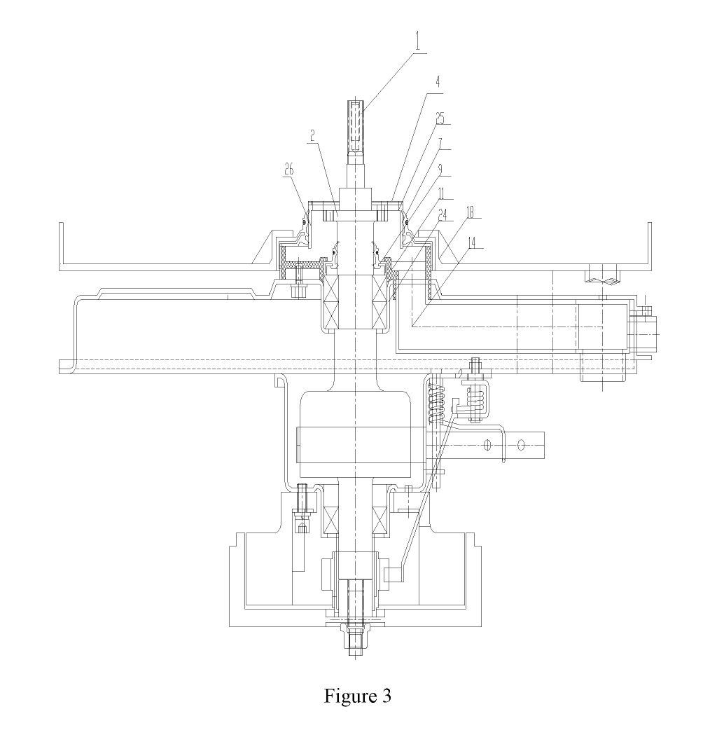

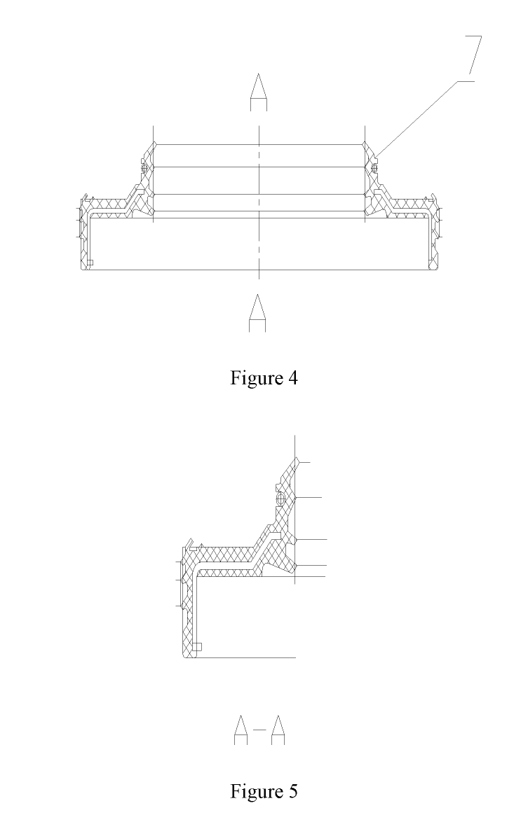

In the figure: 1. pulsator shaft, 2. upper shaft sleeve, 3. inverted steel bowl, 4. limber hole, 5. stainless steel sleeve, 6. O-ring seal, 7. upper water-seal, 8. upper cover of the cavity, 9. big water-seal of the clutch, 10. gasket, 11. lower cover of the cavity, 12. internal outlet, 13. air chamber, 14. water flow chamber, 15. drain valve, 16. balance ring, 17. water-draining hole, 18. wash bucket body, 19. external bucket, 20. pulsator, 21, flange, 22, bottom of wash bucket, 23, external outlet, 24, mounting plate, 25, connecting plate, 26, connecting ring.

### SPECIFIC EMBODIMENTS

### Embodiment 1

The water-sealed clutch is the addition of a set of water-sealing system based on the traditional washing machine clutch, that is, addition of a mechanical seal device. The specific embodiment is that an inverted steel bowl 3 is mounted on the upper shaft sleeve 2 of the clutch, and a number of limber holes 4 are arranged on the inverted steel bowl 3. A stainless steel sleeve 5 is fixed on the inverted steel bowl 3, and the two are sealed and fixedly mounted together, which may be forced fit or welded, etc. The two form a xenogenous inverted steel bowl, which increases the cross-sectional area of the limber holes.

The cavity shell is composed of the upper cover of the cavity 8 and the lower cover of the cavity 11, inserted into the groove of the big water-seal of the clutch 9, and fixedly connected to the bottom plate of the mounting plate of the clutch 24. An upper water-seal 7 with an inner diameter matching the stainless steel sleeve 5 is fixed in the upper cover of the cavity 8. In this way, the upper cover of the cavity 8, lower cover of the cavity 11, upper water-seal 7, stainless steel sleeve 5, big water-seal of the clutch 9, and upper sleeve of the clutch 2, etc. form a cavity. In the upper part, the limber hole 4 connects with the inside of the wash bucket. In the lower part, the internal outlet 12 is arranged at the lower position of the lower cavity cover 11, and connects with the outside of the external bucket 19 via the mounting plate of the clutch 24. Between the upper water-seal 7 and the stainless steel sleeve 5 is a rotary sealing structure, which ensures no water leakage in the wash bucket while the stainless steel sleeve 5 rotates with the upper sleeve 2 and the inverted steel bowl 3.

The clutch used here may be an ordinary deceleration clutch, or a dual-power clutch or a three-power clutch, etc. During the washing process, the wash bucket is allowed to rotate or not to rotate.

The inverted steel bowl 3 has a circular bowl-like structure, and is coaxially mounted on the upper sleeve of the clutch 2. The stainless steel sleeve 5 has a circular structure, is sealed and fixed with the inverted steel bowl 3, and ensures the ring surface where the stainless steel sleeve 5 and the upper water-seal 7 fit is coaxial with the upper shaft sleeve of the clutch 2. The stainless steel sleeve 5 has an inner diameter of between 40 mm and 100 mm. The diameter of the upper sleeve of the clutch is 25 mm here. The annular area within the inner diameter of the stainless steel sleeve 5 and outside the shaft neck of the upper shaft sleeve is the discharge area. The structure here is an annular structure, the passage section is at least 8 cm² and impurities generally will not be blocked here, which ensures smooth water flow.

The upper cover of the cavity 8 and lower cover of the cavity 11 are both of the circular structure, and are coaxially and hermetically fixed together. A positioning structure can be designed between the two, and plate welding or bolts plus sealing strips may be used for connection to ensure no water leakage between the two, and to ensure coaxiality between the two. The upper cover of the cavity 8 has a structure that fixes the upper water-seal 7, and ensures coaxiality between the upper water-seal 7 and upper cover of the cavity 8. The lower end of the lower cover of the cavity 11 has a circle of ring reinforcements which fit tightly with the groove of the big water-seal of the clutch 9, ensure that the lower cover of the cavity 11 and the upper shaft sleeve of the clutch 2 are coaxially mounted, and ensure coaxiality between the two. The upper cover of the cavity 8 and the lower cover of the cavity 11, which are fixed together, are fixedly connected to the mounting plate of the clutch 24, which ensures coaxiality between the upper water-seal 7 and upper shaft sleeve 2, and further ensures coaxiality between the stainless steel sleeve 5 and the upper water-seal 7, and ensures the ideal motion sealing effect. The internal outlet 12 is also arranged at the lower end of the lower cover of the cavity 11, and corresponding holes are arranged on the mounting plate of the clutch 24 to allow the internal outlet 12 to protrude to the bottom surface under the mounting plate of the clutch. Further, there is an O-ring seal 6 around the outer side of the inverted steel bowl 3 and a gasket 10 around the upper cover of the cavity. In this way, a mechanical seal structure is added to the conventional clutch, and a water-sealed clutch is formed, creating a perfect overall structure. It can not only achieve the transmission power of the traditional washing machine clutch and the function of clutch switching, but also has the function of motion sealing, which directly connects water in the wash bucket to the lower end surface of the clutch mounting plate, namely the outer side position at the bottom of the external bucket.

The washing machine using the sealed clutch is a holeless wash-bucket washing machine. The wash bucket body of the washing machine 18 and the bottom of the wash bucket 22 are fixedly connected together. In the washing bucket body 18, only the position in the upper part near the balance ring 16 has a circle of water-draining holes 17, and the other positions are of a holeless structure. The bottom of the wash bucket 22 is sealed and fixed with the flange 21. When the whole machine is installed and when the flange 21 is fixedly connected with the upper sleeve of the clutch 2, the inner surface of the flange 21 is pressed on the O-ring on the inverted steel bowl 3, and the flange and the O-ring are sealed and match each other.

A round hole may be arranged in the middle of the bottom of the external bucket 19, and its diameter may allow the upper half of the water-sealed clutch to pass. The structure around the outer side of the round hole at the bottom of the external bucket 19 is a plane structure. When the water-sealed clutch is installed at the bottom of the external bucket 19, the gasket 10 is pressed against the end surface of the upper cover of the cavity 8 and the peripheral ring surface of the through hole at the middle of the external bucket 19 to allow the upper cover of the cavity and the through hole to seal and match each other. The through hole at the middle of the bottom of the external bucket 19 can be designed with a ring flange on the inner side, which increases the strength here while ensuring no leakage here.

An external outlet 23 is provided outside the cavity of the bottom of the external bucket 19. The external outlet 23 may be connected with the water outlet of the drain valve 15 of the washing machine, or drains away water separately. Outside the bottom cavity of the external bucket 19, there is no water in the process of washing, water intake, water drainage, etc., and there is water at the bottom of the external bucket only during high-speed dewatering. As a result, as long as the external outlet is big enough, the water thrown flows out quickly, and no water flows through the through hole, thus avoiding water leakage here.

The internal outlet 12 connects with the water inlet of the drain valve 15 through the water pipe 14, and meanwhile connects with the air chamber 13 of the water level sensor. When water flows in, it flows in from the inlet valve, enters the wash bucket, enters the cavity from the limber holes 4, enters the water pipe 14 from the internal outlet 12, and enters the air chamber 13 of the water level sensor. The water level sensor senses the water level, and starts the washing mode when the water level reaches the set water level. After washing is finished, the drainage mode starts. In water drainage, the drain valve opens first. Water in the wash bucket passes through the limber holes 4, cavity chamber, internal outlet 12, water pipe 14, enters the water inlet of the drain valve 15. Since the drain valve 15 is open, water is discharged. Meanwhile the water level sensor 13 can still sense the amount of water in wash bucket. After water is emptied, the washing machine enters the dewatering state. Water in the wash bucket is partially discharged from the internal outlet 12, and is partially thrown out from the water-draining hole 17 on the wash bucket body as a result of the centrifugal force, enters the external bucket 19, and then is discharged from the external outlet 23.

This embodiment can effectively improve the coaxiality of the stainless steel sleeve 2 which is a mechanical sealing element and the upper water-seal 7, and greatly increase the service life and sealing effect of the upper water-seal 7. The xenogenous inverted steel bowl composed of the inverted steel bowl 3 and the stainless steel sleeve 5 can greatly increase the sectional area of the limber holes, and avoid blockage here. Meanwhile, the mechanical seal structure is designed such that it is integrated into the deceleration clutch. When the whole machine is installed, it is not necessary to separately install the inverted steel bowl and the cavity cover, which, in particular, resolves the difficulty in operating the inner side of the bottom of the external bucket during installation of the cavity cover.

In Embodiment 2, this invention discloses a water-sealed clutch, and a connecting plate 25 is installed on the upper shaft sleeve 2 of such clutch. On the connecting plate 25, the limber holes 4 are arranged, and are located at the position where the connecting plate 25 and the upper shaft sleeve 2 are connected, and are on the side that is away from the pulsator shaft. A downward connecting ring 26 is arranged at the edge of the connecting plate 25. The external wall of the connecting ring 26 is equipped with a sliding upper water-seal 7, which ensures no water leakage in the wash bucket while the connecting ring 26 rotates with the upper shaft sleeve 2 and connecting plate 25. The upper water-seal 7 and the lower cover of the cavity 11 form a hollow cavity structure, namely a water flow cavity. The space of the water flow chamber is composed of the connecting ring 26, upper water-seal 7, lower cover of the cavity 11, upper shaft sleeve 2, and big water-seal of the clutch 9. The said cavity structure is limited and fixed by the connecting ring 26, wash bucket body 18, and mounting plate 24. In the clutch, the big water-seal of the clutch 9 is arranged at the joint with the lower cover of the cavity 11. The said big water-seal of the clutch 9 is a sealing element arranged between the dewatering shaft and the clutch in the existing technology. On the lower cover of the cavity 11 is the internal outlet 12, which connects with the drainage structure of the washing machine through the water flow chamber 14 by passing through the mounting plate 24 of the clutch. The setting of the upper cover of the cavity 8 is reduced compared to Embodiment 1. The upper cover of the cavity 8 and the upper water-seal 7 in Embodiment 1 are made of the same materials into one piece.

Preferably, the said connecting plate 25 and connecting ring 26 may be fixed together by assembly, or be integrally formed. The connecting plate 25, connecting ring 26 and upper shaft sleeve 2 are fixed together to form a drainage cylinder, and the washing water flows into the drainage cylinder through the limber holes 4. The lower part of the drainage cylinder connects with the upper part of the water flow chamber. The distance from the connecting ring 26 to the outer wall of the upper shaft sleeve 2 is greater than the distance between the outer wall of the limber holes 4 that stays away from the upper shaft sleeve 2 and the outer wall of the upper shaft sleeve 2, which realizes rapid discharge of washing water.

The washing water flows into the drainage cylinder through the limber holes 4, enters the water flow chamber, and then connects with the drainage structure of the washing machine through the water flow chamber 14.

Further, the bolt holes are arranged on the lower cover of the cavity 11. The said bolt holes do not penetrate the lower cover of the cavity 11, and are configured to fix and connect the lower cover of the cavity 11 with the mounting plate 24.

This invention also discloses a water-saving washing machine, including the water-sealed deceleration clutch described in the above embodiment.

In the embodiment described in this invention, the connecting plate 25 and the inverted steel bowl 3 may be structurally interchangeable under certain circumstances, and the connecting ring 26 and the stainless steel sleeve 5 may also be structurally interchangeable. In the water intake mode of the connecting plate, washing water flows in from top to bottom. In the water intake mode of the inverted steel bowl, washing water can flow in from a side, or flow in both from a side and from the upper surface, so as to increase the water inflow efficiency of the limber holes 4.

It should be noted that those ordinary technicians in this field may also improve and modify this invention under the premise that they follow the principle of this invention, and such improvement and modification also fall into the scope of protection of this invention.

1. A water-sealed clutch, comprising: a mechanical seal device is added based on the traditional clutch; wherein
a connecting plate is installed on the upper shaft sleeve of the clutch, and the connecting plate has limber holes;
on the connecting plate is a downward connecting ring;
a cavity shell composed of the upper cavity cover and the lower cavity cover is inserted into the big water-seal groove of the clutch, and is fixed to the bottom plate of the mounting plate of the clutch;
an upper water-seal is fixed in the upper cover of the cavity, and the inner diameter of such upper water-seal matches the connecting ring such that the upper cover of the cavity, a lower cover of the cavity, an upper water-seal, a connecting ring, a water-seal of the clutch, and an upper shaft sleeve of the clutch form a cavity;
an upper part of the cavity has limber holes that connect with an inside of a wash bucket;
a lower part of the lower cover of the cavity has an internal outlet that connects with an outside of the wash bucket via the mounting plate of the clutch; and
a rotary sealing structure between the upper water-seal and a stainless steel sleeve.

2. A water-sealed clutch according to claim 1, wherein said connecting plate is an inverted steel bowl, which is fixedly mounted with the upper sleeve of the clutch; said connecting ring is a stainless steel sleeve, and the inverted steel bowl and the stainless steel sleeve are sealed and fixed together.

3. A water-sealed clutch according to claim 2, wherein the inverted steel bowl has a circular bowl-like structure and is coaxially mounted on the clutch sleeve; the stainless steel sleeve has a circular structure, which is sealed and fixed with the inverted steel bowl, and ensures that the ring surface of the stainless steel sleeve that matches the water-seal is coaxially mounted with the upper shaft sleeve of the clutch; and the stainless steel sleeve has an inner diameter of between 40 mm and 100 mm.

4. A water-sealed clutch according to claim 1, wherein the upper cover of the cavity and the lower cover of the cavity both of circular structures, are fixed to each other coaxially and hermetically, and are fixed with welding or bolts; the upper cover of the cavity has a fixed upper water-sealed structure, and the lower cover of the cavity has a ring reinforcement that fits tightly with the big water-sealed groove of the clutch; and the upper cover of the cavity and the lower cover of the cavity, which are fixed together, are fixedly connected to the mounting plate of the clutch.

5. A water-sealed clutch according to claim 4, wherein said upper cover of the cavity and the upper water-seal are made of the same materials in one piece.

6. A water-sealed clutch according to claim 4, wherein the lower end of the lower cover of the cavity is provided with the inner outlet; and a hole is formed in the corresponding position on the mounting plate of the clutch, so that the internal outlet protrudes to the bottom surface under the mounting plate of the clutch.

7. A water-sealed clutch according to claim 5, wherein an O-ring seal is around the outer side of the inverted steel bowl and a gasket is around the upper cover of the cavity.

8. A water-saving washing machine, that includes a water-sealed clutch comprising: a mechanical seal device is added based on the traditional clutch; wherein a connecting plate is installed on the upper shaft sleeve of the clutch, and the connecting plate has limber holes; on the connecting plate is a downward connecting ring; a cavity shell composed of the upper cavity cover and the lower cavity cover is inserted into the big water-seal groove of the clutch, and is fixed to the bottom plate of the mounting plate of the clutch; an upper water-seal is fixed in the upper cover of the cavity, and the inner diameter of such upper water-seal matches the connecting ring such that the upper cover of the cavity, a lower cover of the cavity, an upper water-seal, a connecting ring, a water-seal of the clutch, and an upper shaft sleeve of the clutch form a cavity; an upper part of the cavity has limber holes that connect with an inside of a wash bucket a lower part of the lower cover of the cavity has an internal outlet that connects with an outside of the wash bucket via the mounting plate of the clutch; and a rotary sealing structure between the upper water-seal and a stainless steel sleeve; wherein
the washing machine using the sealed clutch is a holeless wash-bucket washing machine;
the wash bucket body of the washing machine and the bottom of the wash bucket are fixedly connected together;
in the washing bucket body, only a position in the upper part near a balance ring has a circle of water-draining holes, and the other positions are of a holeless structure;
the bottom of the wash bucket is sealed and fixed with the flange;
when the whole machine is installed and when the flange is fixedly connected with the upper sleeve of the clutch, the inner surface of the flange is pressed on the O-ring on the inverted steel bowl, and the flange and the O-ring are sealed and match each other;
when the water-sealed clutch is installed at the bottom of the external bucket, the gasket is pressed against the end surface of the upper cover of the cavity and the peripheral ring surface of the through hole at the middle of the outer bottom of the external bucket to allow the upper cover of the cavity and the through hole to seal and match each other.

9. A water-saving washing machine according to claim 8, wherein an external outlet is provided outside the cavity of the bottom of the external bucket; the external outlet at least one of is connected with the water outlet of the drain valve of the washing machine, and drains away water separately; and the internal outlet connects with the water inlet of the drain valve through the water pipe, while being connected with an air chamber of a water level sensor.
